(19) United States
(12) Patent Application Publication
(10) Pub. No.: US 2024/0265296 A1
(43) Pub. Date: Aug. 8, 2024

(54) SYSTEMS AND METHODS FOR USER-EDGE ASSOCIATION BASED ON VEHICLE HETEROGENEITY FOR REDUCING THE HETEROGENEITY IN HIERARCHICAL FEDERATED LEARNING NETWORKS

(71) Applicant: TOYOTA MOTOR ENGINEERING & MANUFACTURING NORTH AMERICA, INC., Plano, TX (US)

(72) Inventors: HAO GAO, Mountain View, CA (US); Yongkang LIU, Mountain View, CA (US); Emrah Akin SISBOT, Mountain View, CA (US)

(73) Assignees: TOYOTA MOTOR ENGINEERING & MANUFACTURING NORTH AMERICA, INC., Plano, TX (US); TOYOTA JIDOSHA KABUSHIKI KAISHA, Toyota-shi (JP)

(21) Appl. No.: 18/164,518

(22) Filed: Feb. 3, 2023

(51) Int. Cl. G06N 20/00

(52) U.S. Cl. CPC G06N 20/00; B60R 16/023

(57) ABSTRACT

Systems and methods are provided for vehicular assisted hierarchical federated learning using a vehicle-to-edge server association scheme that reduces statistical heterogeneity in hierarchical federated learning networks. According to some embodiments, the methods and systems comprise obtaining system conditions of a vehicle based on joining a hierarchical federated learning network, exchanging data between the vehicle and edge servers of the hierarchical federated learning network according to a vehicle-to-edge server association protocol that is based on the vehicular system conditions, and identifying a model for the vehicle from models hosted on the edge servers. Embodiments disclosed herein also include at least one of: training the identified model at the vehicle to produce a locally trained model, and applying data acquired by the vehicle to the identified model to perform a task.

### TECHNICAL FIELD

The present disclosure relates generally to systems and methods for hierarchical federated learning, and, more particularly, some embodiments relate to a vehicle-to-edge server association that is based on vehicular system heterogeneity for reducing data heterogeneity in hierarchical federated learning network.

### DESCRIPTION OF RELATED ART

Machine learning approaches train mathematical models to perform tasks such as making predictions based on input features. Autonomous vehicles and intelligent driving-assistance systems increasingly rely on machine-learning approaches to accomplish their tasks. For example, a machine learning model can be trained to recognize objects from RGB images or to predict the trajectory of external road agents (e.g., vehicles, cyclists, pedestrians, etc.) based on various types of input sensor data. Training a machine-learning model translates to optimizing its parameters to maximize the accuracy of its predictions. Model training usually requires a large amount of training data and, for vehicular applications, this data comes from vehicular onboard sensors and computers. Conventionally, machine learning models are trained by compiling the available data at a single server and performing machine-learning-model training using that available data. However, for vehicular applications, there are disadvantages of this centralized machine-learning approach. First, vehicular sensor and onboard computer data may contain privacy-sensitive information about vehicle owners that the vehicle owners do not want to share. Second, vehicles may have limited connectivity to a cloud server and the connection, when available, is often over a tariffed cellular communication link. Therefore, it is disadvantageous to transmit large quantities of data required for model training to a cloud server.

### BRIEF SUMMARY OF THE DISCLOSURE

According to various embodiments of the disclosed technology, systems and methods for managing vehicles to mitigate risk to the vehicles due to anomalous driving behavior are provided.

In accordance with some embodiments, a method for vehicular assisted hierarchical federated learning is provided. The method comprises, responsive to joining a hierarchical federated learning network, obtaining vehicular system conditions of a vehicle. The method also comprises exchanging data between the vehicle and a plurality of edge servers of the hierarchical federated learning network according to a vehicle-to-edge server association protocol that is based on the vehicular system conditions, and identifying a machine learning model for the vehicle from a plurality of machine learning models hosted on the plurality of edge servers using data acquired by the vehicle. The method further comprises at least one of: training the identified machine learning model to perform a task using the data acquired by the vehicle to produce a locally trained machine learning model, and applying the data acquired by the vehicle to the identified machine learning model to perform a task.

In another aspect, a vehicle is provided that comprises a communication circuit configured to exchange communications with edge servers of a hierarchical federated learning, a memory storing instructions network, and one or more processors communicably coupled to the memory. The one or more processors are configured to execute the instructions to obtain vehicular system conditions of the vehicle responsive to joining a hierarchical federated learning network, exchange data with a plurality of edge servers of a hierarchical federated learning network according to a vehicle-to-edge server association protocol that is based on the vehicular system conditions, and identify a machine learning model for the vehicle from a plurality of machine learning models hosted on the plurality of edge servers using data acquired by the vehicle. The one or more processors are further configured to execute the instructions to, at least one of, train the identified machine learning to perform a task using the data acquired by the vehicle to produce a locally trained machine learning model, and apply the data acquired by the vehicle to the identified machine learning model to perform a task.

In another aspect, a server of a hierarchical federated learning network is provided that comprises a communication circuit configured to exchange communications with at least one vehicle of a hierarchical federated learning network, a memory storing instructions network, and one or more processors communicably coupled to the memory. The one or more processors are configured to execute the instructions to exchange data with the at least one vehicle of the hierarchical federated learning network according to a vehicle-to-edge server association protocol selected based on vehicular system conditions of the at least one vehicle, receive a model trained locally by the at least one vehicle using data acquired by the vehicle based on the vehicle-to-edge server association, and aggregate the machine learning model and the locally trained model to generate an aggregate machine learning model.

Other features and aspects of the disclosed technology will become apparent from the following detailed description, taken in conjunction with the accompanying drawings, which illustrate, by way of example, the features in accordance with embodiments of the disclosed technology. The summary is not intended to limit the scope of any inventions described herein, which are defined solely by the claims attached hereto.

### BRIEF DESCRIPTION OF THE DRAWINGS

The present disclosure, in accordance with one or more various embodiments, is described in detail with reference to the following figures. The figures are provided for purposes of illustration only and merely depict typical or example embodiments.

FIG. 1 is a schematic representation of an example hybrid vehicle with which embodiments of the systems and methods disclosed herein may be implemented.

FIG. 2 illustrates an example architecture for vehicular assisted hierarchical federated learning in accordance with one embodiment of the systems and methods described herein.

FIG. 3 is an example network architecture of hierarchical federated learning system in accordance with various embodiments disclosed herein.

FIG. 4 is a flow chart illustrating example operations for vehicular assisted hierarchical federated learning in accordance with various embodiments disclosed herein.

FIG. 5 is an example computing component that may be used to implement various features of embodiments described in the present disclosure.

The figures are not exhaustive and do not limit the present disclosure to the precise form disclosed.

### DETAILED DESCRIPTION

Embodiments of the disclosed technology provide a vehicle-to-edge server association scheme that reduces statistical heterogeneity in hierarchical federated learning networks. The embodiments disclosed herein leverage vehicle system heterogeneity conditions, such as computational resources (e.g., computation power, storage capacity, etc.) and privacy requirements settings specific to a vehicle (or end-user), to select a server for contributing to vehicular-assisted in of a hierarchical federated learning.

As alluded to above, there are disadvantages to transmitting large quantities of data needed for model training in centralized machine learning platforms. Federated machine learning platforms (or networks) have been leveraged to reduce the this amount of data. In federate learning, machine learning models are trained at the vehicle side rather than at a centralized or edge server. Federated learning is an iterative process in which a vehicle downloads a machine learning model to train the model locally on vehicle data (e.g., data acquired by the vehicle sensors and subsystems). The vehicle shares the locally trained models with a server, which aggregates locally trained models from a number of vehicles and shares the global aggregated model for accomplishing vehicle tasks. The global aggregated model is then a starting point for a subsequent iteration of local training at the vehicle side and aggregation at the server side. One major benefit of federated learning is that the vehicles need only transmit model parameters to a server, instead of large quantities of raw sensor data. This significantly reduces communication overhead and also overcomes privacy issues.

One challenging problem in real-world federated learning networks is data heterogeneity. This problem is a result of vehicles generating and collecting data in a non-identically distributed manner across a federated learning network. In other words, vehicles collect data under varying driving scenarios across the federated learning network, which are used to locally train a model. For example, a vehicle in Washington may experience many cold and steep driving scenarios, while a vehicle in Texas may experience warm and flat driving scenarios. In a large, federated learning network, these differences are extrapolated across numerous vehicles and numerous variations, and as a result there exists a large statistical heterogeneity in the data. When the heterogeneous data is used to train local models in a federated learning network, the resulting global model may not work well for all users because of the differences in data used for training. That is, a global model trained on experiences in Texas may not work well for vehicles in Washington, and vice versa.

Accordingly, hierarchical federated learning networks have been leveraged to mitigate the impact of the statistical heterogeneity problem. hierarchical federated learning networks provide a hierarchical framework to a federated learning network, in which edge servers are used to aggregate locally train models according to characteristics of the scenario's experienced by the vehicles. That is, hierarchical federated learning networks train customized characteristic-centric models on edge servers, each of which being trained using data acquired under similar scenario characteristics. For example, with reference to the above example, vehicles in Washington may locally train a model using the vehicle data, which includes characteristics specific to driving experiences in Washington. An edge server assigned to Washington collects the Washington relevant locally trained models to generate a Washington-centric model, which can be used by vehicles driving in Washington to accomplish tasks. Similarly, another edge server can collect locally trained Texas relevant models and provide a Texas-centric model. Thus, hierarchical federated learning networks can learn characteristic-centric models on edge servers that will work best for the characteristics on which each model was trained.

One challenging problem in hierarchical federated learning networks is that, when a vehicle joins a hierarchical federated learning network, the hierarchical federated learning network may need to decide which edge server the vehicle should connect to for contributing to training and receiving trained models. For example, the hierarchical federated learning networks may need to decide if a new vehicle should contribute to and receive a Washington-centric model, a Texas-centric model, etc. and connect the vehicle to the corresponding edge server. For some applications, this decision can be relativity straightforward because there may exist clear characteristics (such as, geolocation, vehicle type, vehicle model, and other objective characteristics). However, for certain scenarios, such as more subjective characteristics, the decision may not be as obvious. For example, different users may exhibit different driving styles (e.g., aggressive, cautious, anxious, etc.) and the hierarchical federated learning network may need to decide which of the edge servers to communicate with based on driving style.

One of the keys to making the above decision is to identify differences between data collected by different vehicles connected to a specific edge server. The characteristic-centric models on edge serves work best when the differences between vehicle are minimized. Conventional approaches have been proposed, for example, by dynamically associating users to edge servers in hierarchical federated learning networks. In one approach, user association decisions were computed by evolutionary game and Stackelberg differential game theory. However, the numerical methods to solve these game theories incurs high time and space complexity. This approach also suffers from high dimensionality disadvantages. In another approach, weighted distance between different classes of users was minimized to reduce the data heterogeneity in the system. However, this approach only considers the variances between the collected data (referred to herein as data heterogeneity), with no consideration on system heterogeneity between end-user systems (e.g., variances in the systems conditions that are used to collect data).

Embodiments disclosed herein provide for a vehicle-to-edge server association scheme that considers vehicular system heterogeneity in selecting an edge server to connect with a vehicle. Various association protocols are disclosed herein for identifying an optimal characteristic-centric model for a vehicle based on the vehicle's system conditions. As used herein, system conditions may refer to system requirements and capabilities that are heterogeneous between vehicles in a hierarchical federated learning network. Examples of system heterogeneity includes, but is not limited to, computational resource (e.g., computation power, memory capacity, etc.) and privacy requirement settings that control whether or not certain data (or any data) can be transmitted external to the system. In various embodiments disclosed herein, system conditions used to select which association protocol, which is then executed to identify an optimal characteristic-centric model for a specific vehicle. The vehicle is then associated with (e.g., connected to) an edge server hosting the identified characteristic-centric model, through which the vehicle can contribute to the hierarchical federated learning network by training and/or using the characteristic-centric model. As a result, data heterogeneity between users contributing to characteristic-centric models can be reduced through identification of optimal models based on system heterogeneity and associating vehicles with edge serves hosting the optimal models.

It should be noted that the terms “optimize,” “optimal” and the like as used herein can be used to mean making or achieving performance as effective or perfect as possible. However, as one of ordinary skill in the art reading this document will recognize, perfection cannot always be achieved. Accordingly, these terms can also encompass making or achieving performance as good or effective as possible or practical under the given circumstances, or making or achieving performance better than that which can be achieved with other settings or parameters.

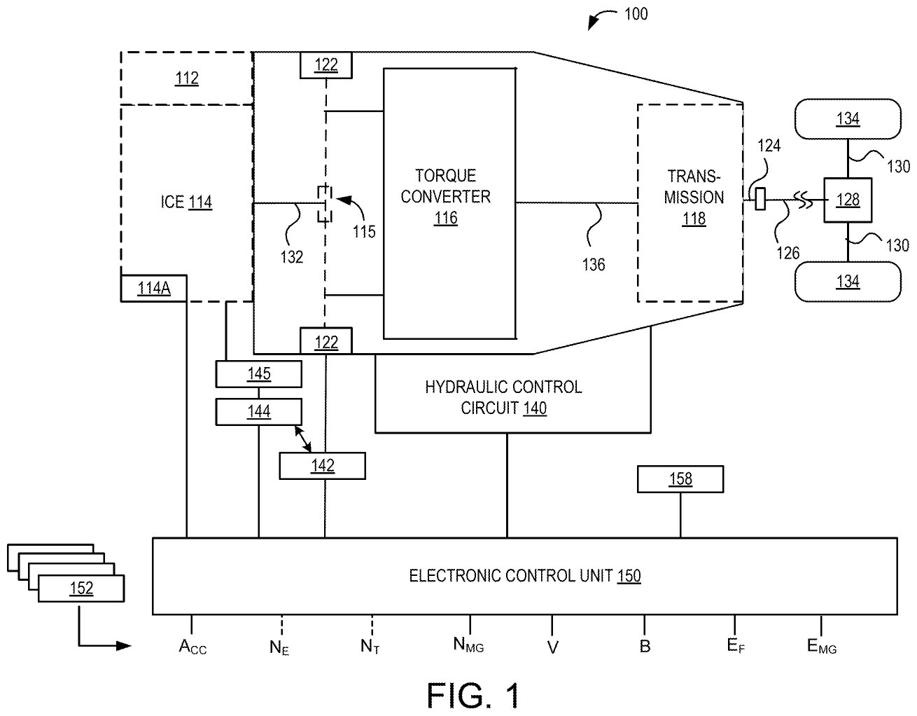

The systems and methods disclosed herein may be implemented with any of a number of different vehicles and vehicle types. For example, the systems and methods disclosed herein may be used with automobiles, trucks, motorcycles, recreational vehicles and other like on-or off-road vehicles. In addition, the principals disclosed herein may also extend to other vehicle types as well. An example hybrid electric vehicle (HEV) in which embodiments of the disclosed technology may be implemented is illustrated in FIG. 1. Although the example described with reference to FIG. 1 is a hybrid type of vehicle, the systems and methods for contributing to a hierarchical federated learning network can be implemented in other types of vehicles including gasoline- or diesel-powered vehicles, fuel-cell vehicles, electric vehicles, or other vehicles.

FIG. 1 illustrates a drive system of an example vehicle 100 that may include an internal combustion engine 114 and one or more electric motors 122 (which may also serve as generators) as sources of motive power. Driving force generated by the internal combustion engine 114 and motors 122 can be transmitted to one or more wheels 134 via a torque converter 116, a transmission 118, a differential gear device 128, and a pair of axles 130.

As an HEV, vehicle 100 may be driven/powered with either or both of engine 114 and the motor(s) 122 as the drive source for travel. For example, a first travel mode may be an engine-only travel mode that only uses internal combustion engine 114 as the source of motive power. A second travel mode may be an EV travel mode that only uses the motor(s) 122 as the source of motive power. A third travel mode may be an HEV travel mode that uses engine 114 and the motor(s) 122 as the sources of motive power. In the engine-only and HEV travel modes, vehicle 100 relies on the motive force generated at least by internal combustion engine 114, and a clutch 115 may be included to engage engine 114. In the EV travel mode, vehicle 100 is powered by the motive force generated by motor 122 while engine 114 may be stopped and clutch 115 disengaged.

Engine 114 can be an internal combustion engine such as a gasoline, diesel or similarly powered engine in which fuel is injected into and combusted in a combustion chamber. A cooling system 112 can be provided to cool the engine 114 such as, for example, by removing excess heat from engine 114. For example, cooling system 112 can be implemented to include a radiator, a water pump and a series of cooling channels. In operation, the water pump circulates coolant through the engine 114 to absorb excess heat from the engine. The heated coolant is circulated through the radiator to remove heat from the coolant, and the cold coolant can then be recirculated through the engine. A fan may also be included to increase the cooling capacity of the radiator. The water pump, and in some instances the fan, may operate via a direct or indirect coupling to the driveshaft of engine 114. In other applications, either or both the water pump and the fan may be operated by electric current such as from battery 144.

An output control circuit 114A may be provided to control drive (output torque) of engine 114. Output control circuit 114A may include a throttle actuator to control an electronic throttle valve that controls fuel injection, an ignition device that controls ignition timing, and the like. Output control circuit 114A may execute output control of engine 114 according to a command control signal(s) supplied from an electronic control unit 150, described below. Such output control can include, for example, throttle control, fuel injection control, and ignition timing control.

Motor 122 can also be used to provide motive power in vehicle 100 and is powered electrically via a battery 144. Battery 144 may be implemented as one or more batteries or other power storage devices including, for example, lead-acid batteries, nickel-metal hydride batteries, lithium ion batteries, capacitive storage devices, and so on. Battery 144 may be charged by a battery charger 145 that receives energy from internal combustion engine 114. For example, an alternator or generator may be coupled directly or indirectly to a drive shaft of internal combustion engine 114 to generate an electrical current as a result of the operation of internal combustion engine 114. A clutch can be included to engage/disengage the battery charger 145. Battery 144 may also be charged by motor 122 such as, for example, by regenerative braking or by coasting during which time motor 122 operate as generator.

Motor 122 can be powered by battery 144 to generate a motive force to move the vehicle and adjust vehicle speed. Motor 122 can also function as a generator to generate electrical power such as, for example, when coasting or braking. Battery 144 may also be used to power other electrical or electronic systems in the vehicle. Motor 122 may be connected to battery 144 via an inverter 142. Battery 144 can include, for example, one or more batteries, capacitive storage units, or other storage reservoirs suitable for storing electrical energy that can be used to power motor 122. When battery 144 is implemented using one or more batteries, the batteries can include, for example, nickel metal hydride batteries, lithium ion batteries, lead acid batteries, nickel cadmium batteries, lithium ion polymer batteries, and other types of batteries.

An electronic control unit 150 (described below) may be included and may control the electric drive components of the vehicle as well as other vehicle components. For example, electronic control unit 150 may control inverter 142, adjust driving current supplied to motor 122, and adjust the current received from motor 122 during regenerative coasting and breaking. As a more particular example, output torque of the motor 122 can be increased or decreased by electronic control unit 150 through the inverter 142.

A torque converter 116 can be included to control the application of power from engine 114 and motor 122 to transmission 118. Torque converter 116 can include a viscous fluid coupling that transfers rotational power from the motive power source to the driveshaft via the transmission. Torque converter 116 can include a conventional torque converter or a lockup torque converter. In other embodiments, a mechanical clutch can be used in place of torque converter 116.

Clutch 115 can be included to engage and disengage engine 114 from the drivetrain of the vehicle. In the illustrated example, a crankshaft 132, which is an output member of engine 114, may be selectively coupled to the motor 122 and torque converter 116 via clutch 115. Clutch 115 can be implemented as, for example, a multiple disc type hydraulic frictional engagement device whose engagement is controlled by an actuator such as a hydraulic actuator. Clutch 115 may be controlled such that its engagement state is complete engagement, slip engagement, and complete disengagement complete disengagement, depending on the pressure applied to the clutch. For example, a torque capacity of clutch 115 may be controlled according to the hydraulic pressure supplied from a hydraulic control circuit (not illustrated). When clutch 115 is engaged, power transmission is provided in the power transmission path between the crankshaft 132 and torque converter 116. On the other hand, when clutch 115 is disengaged, motive power from engine 114 is not delivered to the torque converter 116. In a slip engagement state, clutch 115 is engaged, and motive power is provided to torque converter 116 according to a torque capacity (transmission torque) of the clutch 115.

As alluded to above, vehicle 100 may include an electronic control unit 150. Electronic control unit 150 may include circuitry to control various aspects of the vehicle operation. Electronic control unit 150 may include, for example, a microcomputer that includes a one or more processing units (e.g., microprocessors), memory storage (e.g., RAM, ROM, etc.), and I/O devices. The processing units of electronic control unit 150, execute instructions stored in memory to control one or more electrical systems or subsystems 158 in the vehicle. Electronic control unit 150 can include a plurality of electronic control units such as, for example, an electronic engine control module, a powertrain control module, a transmission control module, a suspension control module, a body control module, and so on. As a further example, electronic control units can be included to control systems and functions such as doors and door locking, lighting, human-machine interfaces, cruise control, telematics, braking systems (e.g., ABS or ESC), battery management systems, and so on. These various control units can be implemented using two or more separate electronic control units, or using a single electronic control unit.

In the example illustrated in FIG. 1, electronic control unit 150 receives information from a plurality of sensors included in vehicle 100. For example, electronic control unit 150 may receive signals that indicate vehicle operating conditions or characteristics, or signals that can be used to derive vehicle operating conditions or characteristics. These may include, but are not limited to accelerator operation amount, ACC, a revolution speed, NE, of internal combustion engine 114 (engine RPM), a rotational speed, NMG, of the motor 122 (motor rotational speed), and vehicle speed, NV. These may also include torque converter 116 output, NT (e.g., output amps indicative of motor output), brake operation amount/pressure, B, battery SOC (i.e., the charged amount for battery 144 detected by an SOC sensor). Accordingly, vehicle 100 can include a plurality of sensors 152 that can be used to detect various conditions internal or external to the vehicle and provide sensed conditions to engine control unit 150 (which, again, may be implemented as one or a plurality of individual control circuits). In one embodiment, sensors 152 may be included to detect one or more conditions directly or indirectly such as, for example, fuel efficiency, EF, motor efficiency, EMG, hybrid (internal combustion engine 114+MG 112) efficiency, acceleration, ACC, etc.

In some embodiments, one or more of the sensors 152 may include their own processing capability to compute the results for additional information that can be provided to electronic control unit 150. In other embodiments, one or more sensors may be data-gathering-only sensors that provide only raw data to electronic control unit 150. In further embodiments, hybrid sensors may be included that provide a combination of raw data and processed data to electronic control unit 150. Sensors 152 may provide an analog output or a digital output.

Sensors 152 may be included to detect not only vehicle conditions but also to detect external conditions as well. Sensors that might be used to detect external conditions can include, for example, sonar, radar, lidar or other vehicle proximity sensors, and cameras or other image sensors. Image sensors can be used to detect objects in an environment surrounding vehicle 100, for example, traffic signs indicating a current speed limit, road curvature, obstacles, surrounding vehicles, and so on. Still other sensors may include those that can detect road grade. While some sensors can be used to actively detect passive environmental objects, other sensors can be included and used to detect active objects such as those objects used to implement smart roadways that may actively transmit and/or receive data or other information.

The example of FIG. 1 is provided for illustration purposes only as one example of vehicle systems with which embodiments of the disclosed technology may be implemented. One of ordinary skill in the art reading this description will understand how the disclosed embodiments can be implemented with this and other vehicle platforms.

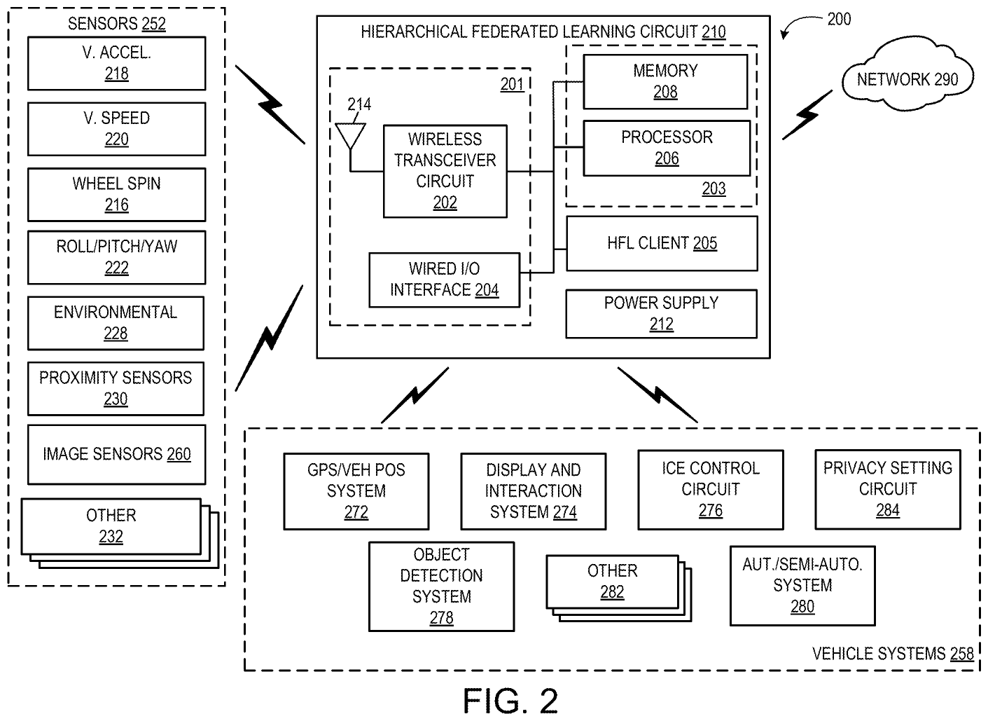

FIG. 2 illustrates an example architecture for contributing to a hierarchical federated learning network in accordance with one embodiment of the systems and methods described herein. Referring now to FIG. 2, in this example, hierarchical federated learning system 200 includes a hierarchical federated learning circuit 210, a plurality of sensors 252 and a plurality of vehicle systems 258. Sensors 252 (such as sensors 152 described in connection with FIG. 1) and vehicle systems 258 (such as subsystems 158 described in connection with FIG. 1) can communicate with hierarchical federated learning circuit 210 via a wired or wireless communication interface. Although sensors 252 and vehicle systems 258 are depicted as communicating with hierarchical federated learning circuit 210, they can also communicate with each other as well as with other vehicle systems. Hierarchical federated learning circuit 210 can be implemented as an ECU or as part of an ECU such as, for example electronic control unit 150. In other embodiments, hierarchical federated learning circuit 210 can be implemented independently of the ECU.

Hierarchical federated learning circuit 210 in this example includes a communication circuit 201, a decision circuit 203 (including a processor 206 and memory 208 in this example) and a power supply 212. Components of hierarchical federated learning circuit 210 are illustrated as communicating with each other via a data bus, although other communication in interfaces can be included. Hierarchical federated learning circuit 210 in this example also includes hierarchical federated learning client 205 that can be operated to connect to an edge server of a network 290 to contribute to training models and/or download models for use by vehicle systems 258. For example, hierarchical federated learning circuit 210 may download a model via communication circuit 201, train the model locally using the vehicle data collected by sensors 252 and/or vehicle systems 258, and then share the locally trained model with the edge server. hierarchical federated learning circuit 210 may also download a customized model (e.g., a model resultant from aggregation of locally trained models) from the edge server for use by vehicle systems 258 to accomplish vehicle tasks.

Processor 206 can include one or more GPUs, CPUs, microprocessors, or any other suitable processing system. Processor 206 may include a single core or multicore processors. In various embodiments, processor 206 may have a computation power based on an amount of computation works the processor 206 can accomplish. The computation power may be measured in instructions-per-second (IPS), which is a measure of computing performs in terms of amount of processing the processor can do. As another example, computation power can be provided in terms of floating point operations-per-second (FLOPS). The computation power may be based on hardware implementations of the processor 206.

The memory 208 may include one or more various forms of memory or data storage (e.g., flash, RAM, etc.) that may be used to store instructions and variables for processor 206 as well as any other suitable information, such as, one or more of the following elements: position data; vehicle speed data; risk and mitigation data, along with other data as needed. Memory 208 can be made up of one or more modules of one or more different types of memory, and may be configured to store data and other information as well as operational instructions that may be used by the processor 206 to hierarchical federated learning circuit 210.

In various embodiments, memory 208 may have a capacity (referred to herein as memory capacity), which is a measure of the amount of data hierarchical federated learning circuit 210 can store at any given time. In some embodiments, memory capacity may be a measure of the amount of capacity available for incoming data (e.g., not already used for storing existing data). In the case of hierarchical federated learning, the memory capacity may be an amount of memory available at any given time for storing one or more models. The one or more models may be accessed by the hierarchical federated learning client 205 for training locally on hierarchical federated learning circuit 210 and/or applying the one or more models to vehicle systems 258 for accomplishing vehicle tasks.

Although the example of FIG. 2 is illustrated using processor and memory circuitry, as described below with reference to circuits disclosed herein, decision circuit 203 can be implemented utilizing any form of circuitry including, for example, hardware, software, or a combination thereof. By way of further example, one or more processors, controllers, ASICs, PLAs, PALs, CPLDs, FPGAs, logical components, software routines or other mechanisms might be implemented to make up a hierarchical federated learning circuit 210.

Communication circuit 201 includes either or both a wireless transceiver circuit 202 with an associated antenna 214 and a wired I/O interface 204 with an associated hardwired data port (not illustrated). Communication circuit 201 can provide for vehicle-to-everything (V2X) and/or vehicle-to-vehicle (V2V) communications capabilities, allowing hierarchical federated learning circuit 210 to communicate with edge devices, such as roadside unit/equipment (RSU/RSE), network cloud servers and cloud-based databases, and/or other vehicles via network 290. For example, V2X communication capabilities allows hierarchical federated learning circuit 210 to communicate with edge/cloud servers, roadside infrastructure (e.g., such as roadside equipment/roadside unit, which may be a vehicle-to-infrastructure (V21)-enabled street light or cameras, for example), etc. Hierarchical federated learning circuit 210 may also communicate with other connected vehicles over vehicle-to-vehicle (V2V) communications.

As this example illustrates, communications with hierarchical federated learning circuit 210 can include either or both wired and wireless communications circuits 201. Wireless transceiver circuit 202 can include a transmitter and a receiver (not shown) to allow wireless communications via any of a number of communication protocols such as, for example, Wi-Fi, Bluetooth, near field communications (NFC), Zigbee, and any of a number of other wireless communication protocols whether standardized, proprietary, open, point-to-point, networked or otherwise. Antenna 214 is coupled to wireless transceiver circuit 202 and is used by wireless transceiver circuit 202 to transmit radio signals wirelessly to wireless equipment with which it is connected and to receive radio signals as well. These RF signals can include information of almost any sort that is sent or received by hierarchical federated learning circuit 210 to/from other entities such as sensors 252 and vehicle systems 258.

Wired I/O interface 204 can include a transmitter and a receiver (not shown) for hardwired communications with other devices. For example, wired I/O interface 204 can provide a hardwired interface to other components, including sensors 252 and vehicle systems 258. Wired I/O interface 204 can communicate with other devices using Ethernet or any of a number of other wired communication protocols whether standardized, proprietary, open, point-to-point, networked or otherwise.

Power supply 212 can include one or more of a battery or batteries (such as, e.g., Li-ion, Li-Polymer, NiMH, NiCd, NiZn, and NiH2, to name a few, whether rechargeable or primary batteries,), a power connector (e.g., to connect to vehicle supplied power, etc.), an energy harvester (e.g., solar cells, piezoelectric system, etc.), or it can include any other suitable power supply.

Sensors 252 can include, for example, sensors 152 such as those described above with reference to the example of FIG. 1. Sensors 252 can include additional sensors that may or may not otherwise be included on a standard vehicle with which the hierarchical federated learning system 200 is implemented. In the illustrated example, sensors 252 include vehicle acceleration sensors 218, vehicle speed sensors 220, wheelspin sensors 216 (e.g., one for each wheel), accelerometers such as a 2-axis accelerometer 222 to detect roll, pitch and yaw of the vehicle, environmental sensors 228 (e.g., to detect salinity or other environmental conditions), and proximity sensor 230 (e.g., sonar, radar, lidar or other vehicle proximity sensors). Additional sensors 232 can also be included as may be appropriate for a given implementation of hierarchical federated learning system 200.

System 200 may be equipped with one or more image sensors 260. These may include front facing image sensors, side facing image sensors, and/or rear facing image sensors. Image sensors may capture information which may be used in detecting not only vehicle conditions but also detecting conditions external to the vehicle as well. Image sensors that might be used to detect external conditions can include, for example, cameras or other image sensors configured to capture data in the form of sequential image frames forming a video in the visible spectrum, near infra-red (IR) spectrum, IR spectrum, ultra violet spectrum, etc. Image sensors 260 can be used to, for example, to detect objects in an environment surrounding a vehicle comprising hierarchical federated learning system 200, for example, surrounding vehicles, roadway environment, road lanes, road curvature, obstacles, and so on. For example, a one or more image sensors 260 may capture images of surrounding vehicles in the surrounding environment. As another example, object detecting and recognition techniques may be used to detect objects and environmental conditions, such as, but not limited to, road conditions, surrounding vehicle behavior (e.g., driving behavior and the like), and the like. Additionally, sensors may estimate proximity between vehicles. For instance, the image sensors 260 may include cameras that may be used with and/or integrated with other proximity sensors 230 such as LIDAR sensors or any other sensors capable of capturing a distance. As used herein, a sensor set of a vehicle may refer to sensors 252.

Vehicle systems 258, for example, systems and subsystems 158 described above with reference to the example of FIG. 1, can include any of a number of different vehicle components or subsystems used to control or monitor various aspects of the vehicle and its performance. In this example, the vehicle systems 258 includes a vehicle positioning system 272; engine control circuits 276 to control the operation of engine (e.g. internal combustion engine 114 and/or motors 122); object detection system 278 to perform image processing such as object recognition and detection on images from image sensors 260, proximity estimation, for example, from image sensors 260 and/or proximity sensors, etc. for use in other vehicle systems; vehicle display and interaction system 274 (e.g., vehicle audio system for broadcasting notifications over one or more vehicle speakers), vehicle display system and/or the vehicle dashboard system), and other vehicle systems 282 (e.g., Advanced Driver-Assistance Systems (ADAS), autonomous or semi-autonomous driving systems 280, such as forward/rear collision detection and warning systems, pedestrian detection systems, autonomous or semi-autonomous driving systems, and the like).

The vehicle positioning system 272 can include a global positioning system (GPS). Hierarchical federated learning circuit 210 may be installed on a DSRC-equipped vehicle. A DSRC-equipped vehicle is a vehicle which: (1) includes a DSRC radio; (2) includes a DSRC-compliant Global Positioning System (GPS) unit; and (3) is operable to lawfully send and receive DSRC messages in a jurisdiction where the DSRC-equipped vehicle is located. A DSRC radio is hardware that includes a DSRC receiver and a DSRC transmitter. The DSRC radio is operable to wirelessly send and receive DSRC messages.

A DSRC-compliant GPS unit is operable to provide positional information for a vehicle (or some other DSRC-equipped device that includes the DSRC-compliant GPS unit) that has lane-level accuracy. In some embodiments, a DSRC-compliant GPS unit is operable to identify, monitor and track its two-dimensional position within 1.5 meters of its actual position 68% of the time under an open sky.

Conventional GPS communication includes a GPS satellite in communication with a vehicle comprising a GPS tracking device. The GPS tracking device emits/receives a signal to/from the GPS satellite. For example, a GPS tracking device is installed into a vehicle. The GPS tracking device receives position data from the GPS tracking device. The position data gathered from the vehicle is stored in the tracking device. The position data is transmitted to the cloud server via a wireless network.

A conventional GPS provides positional information that describes a position of a vehicle with an accuracy of plus or minus 10 meters of the actual position of the conventional GPS unit. By comparison, a DSRC-compliant GPS unit provides GPS data that describes a position of the DSRC-compliant GPS unit with an accuracy of plus or minus 1.5 meters of the actual position of the DSRC-compliant GPS unit. This degree of accuracy is referred to as “lane-level accuracy” since, for example, a lane of a roadway is generally about 3 meters wide, and an accuracy of plus or minus 1.5 meters is sufficient to identify which lane a vehicle is traveling in on a roadway. Some safety or autonomous driving applications provided by an Advanced Driver Assistance System (ADAS) of a modern vehicle require positioning information that describes the location of the vehicle with lane-level accuracy. In addition, the current standard for DSRC requires that the location of the vehicle be described with lane-level accuracy.

Autonomous or semi-autonomous driving systems 280 can be operatively connected to the various vehicle systems 258 and/or individual components thereof. For example, autonomous or semi-autonomous driving systems 280 can send and/or receive information from the various vehicle systems 258 to control the movement, speed, maneuvering, heading, direction, etc. of the vehicle. The autonomous or semi-autonomous driving systems 280 may control some or all of these vehicle systems 258 and, thus, may be semi- or fully autonomous.

In some embodiments, hierarchical federated learning client 205 can be configured to receive data from the sensors 252 and/or any other type of vehicle systems 258 capable of acquiring information (e.g., data) relating to the vehicle and/or the external environment of the vehicle. In various embodiments, the hierarchical federated learning client 205 can use such data to train one or more models stored on memory 208. For example, autonomous or semi-autonomous driving systems 280 (or other sensors 252), can determine position and velocity of the vehicle, and/or location of obstacles or other environmental features including traffic signs, trees, shrubs, neighboring vehicles, pedestrians, etc. Using the data, hierarchical federated learning client 205 can apply the data to one or more models stored in memory 208 to train the one or more models, which outputs a locally trained model that can be shared with an edge server via network 290. The locally trained model can be described by model parameters, such as weights, bias, activation functions, learning rate, layers of neurons, and regularization to name a few. In some embodiments, the locally trained models are shared as a collection of model parameters that describe the locally trained model. The edge server can add the locally generated result parameters to optimize an aggregation of the one or more models. In another example, hierarchical federated learning client 205 can collect the data from sensors 252 and vehicle systems 258 and apply the data to one or more models. The one or more models output parameters that the hierarchical federated learning client 205 can communicate to vehicle systems 258 for controlling operations of the vehicle systems 258 according to the one or more models.

Vehicle systems 258 can also include a privacy setting circuit 284 for controlling data privacy settings of the vehicle. Privacy setting circuit 284 can be configured to control whether or not certain data can be transmitted out of hierarchical federated learning system 200. In some embodiments, privacy setting circuit 284 may be set to strict privacy requirement setting in which only generic data, that does not include any user identifying data or data related to a user of the vehicle, can be communicated outside of the vehicle. In an example, a strict privacy requirement may be that only data needed to request model parameters of a characteristic-centric model from each edge server may be transmitted outside of the vehicle. For example, in a federated learning network, each user's raw data may remain in the vehicle, but there are some features can describe a user's raw data (e.g., max, min, mean value) which are shared during the federated learning. Strict privacy requirement according to the embodiments disclosed herein restricts the sharing of data feature information. In some embodiments, the strict privacy setting may be applied dependent on the type of data. For example, user data may be set to a strict privacy setting, while vehicle data may be available for transmission. In a case where the privacy setting circuit 284 is not set to strict privacy, the privacy requirement may be considered a lenient or mild privacy requirement.

The privacy settings in privacy setting circuit 284 may be set according to a user input or hardwired into the hierarchical federated learning system 200. For example, a user may toggle privacy settings according to user preference. In this case, a user may input a setting into, for example, interaction system 274. In another example, privacy settings may be hardwired into hierarchical federated learning system 200. For example, data related to interworking of the autonomous or semi-autonomous driving systems 280 may be set to strict privacy by a manufacturer to protect systems from malicious interception.

Network 290 may be a conventional type of network, wired or wireless, and may have numerous different configurations including a star configuration, token ring configuration, or other configurations. Furthermore, the network 290 may include a local area network (LAN), a wide area network (WAN) (e.g., the Internet), or other interconnected data paths across which multiple devices and/or entities may communicate. In some embodiments, the network may include a peer-to-peer network. The network may also be coupled to or may include portions of a telecommunications network for sending data in a variety of different communication protocols. In some embodiments, the network 290 includes Bluetooth® communication networks or a cellular communications network for sending and receiving data including via short messaging service (SMS), multimedia messaging service (MMS), hypertext transfer protocol (HTTP), direct data connection, wireless application protocol (WAP), e-mail, DSRC, full-duplex wireless communication, mmWave, Wi-Fi (infrastructure mode), Wi-Fi (ad-hoc mode), visible light communication, TV white space communication and satellite communication. The network may also include a mobile data network that may include 3G, 4G, 5G, LTE, LTE-V2V, LTE-V21, LTE-V2X, LTE-D2D, VoLTE, 5G-V2X or any other mobile data network or combination of mobile data networks. Further, the network 290 may include one or more IEEE 802.11 wireless networks.

In some embodiments, the network 290 includes a V2X network (e.g., a V2X wireless network). The V2X network is a communication network that enables entities such as elements of the operating environment to wirelessly communicate with one another via one or more of the following: Wi-Fi; cellular communication including 3G, 4G, LTE, 5G, etc.; Dedicated Short Range Communication (DSRC); millimeter wave communication; etc. As described herein, examples of V2X communications include, but are not limited to, one or more of the following: Dedicated Short Range Communication (DSRC) (including Basic Safety Messages (BSMs) and Personal Safety Messages (PSMs), among other types of DSRC communication); Long-Term Evolution (LTE); millimeter wave (mmWave) communication; 3G; 4G; 5G; LTE-V2X; 5G-V2X; LTE-Vehicle-to-Vehicle (LTE-V2V); LTE-Device-to-Device (LTE-D2D); Voice over LTE (VoLTE); etc. In some examples, the V2X communications can include V2V communications, Vehicle-to-Infrastructure (V21) communications, Vehicle-to-Network (V2N) communications or any combination thereof.

Examples of a wireless message (e.g., a V2X wireless message) described herein include, but are not limited to, the following messages: a Dedicated Short Range Communication (DSRC) message; a Basic Safety Message (BSM); a Long-Term Evolution (LTE) message; an LTE-V2X message (e.g., an LTE-Vehicle-to-Vehicle (LTE-V2V) message, an LTE-Vehicle-to-Infrastructure (LTE-V21) message, an LTE-V2N message, etc.); a 5G-V2X message; and a millimeter wave message, etc.

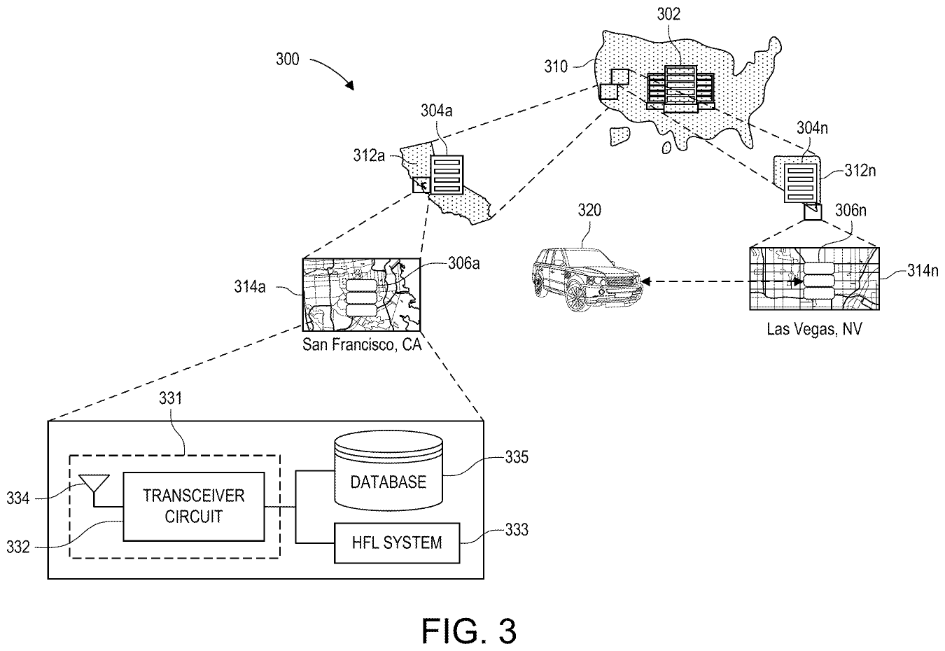

FIG. 3 is a schematic diagram of a hierarchical federated learning architecture 300, in accordance with an illustrative embodiment of the disclosed technology. The architecture 300 includes a plurality of cloud-based servers arranged in a hierarchical framework assigned to various slices of the framework and a vehicle 320, which can communicatively connect to one or more servers.

The servers of FIG. 3 may be one or more cloud-based instances of processor-based computing device residents on a network (e.g. network 290 of FIG. 2) connected in according to the hierarchical framework. For example, at a first slice of the framework, a centralized cloud sever 302 may be provided serving the entirety of hierarchical federated learning network, which may be assigned to a region 310 (e.g., the United States of America in this example). At a second slice, one or more intermediate cloud servers 304a-304n (collectively referred to herein as intermediate servers 304) may be provided, each serving a sub-region 312a-312n of the region 310. In the illustrative example shown in FIG. 3, each sub-region 312a-312n corresponds to a state, with California 310a and Nevada 310n shown for illustrative purposes. At a third slice, a plurality of edge servers 306a-304n (collectively referred to herein as edge servers 306) may be provided, each serving an area 314a-314n of a sub-region 312. In the illustrative example shown in FIG. 3, each area 314a-314n is provided as a metropolitan area, with San Francisco 314a and Las Vegas 314n shown for illustrative purposes.

While three slices (or levels) are shown in FIG. 3, one skilled in the art will appreciate that additional slices may be included as desired for a given application. For example, one or more additional intermediate slices may be provided between the third and second or the second and first slice. Furthermore, additional slices may be included that reside at higher levels of abstraction above the first slice of FIG. 3, and, similarly, additional slices may reside below the third slice depending on the desired application.

The servers 302-306 in this example may be part of a hierarchical federated learning network. Each server 304-306 can include, for example, a microcomputer that includes a one or more processing units (e.g., microprocessors), memory storage (e.g., RAM, ROM, etc.), and I/O devices. An illustrative example is provided for server 306a, which includes a cloud-based database 335, which may be resident on network 290, for storing information and data related to locally trained models (e.g., from users and/or vehicles in the hierarchical federated learning network), along with information and data related to customized models resulting from aggregation of the locally trained models. Processing units of cloud servers execute instructions stored in memory to control functions of a hierarchical federated learning system 333. For example, hierarchical federated learning system 333 may function to collect locally trained models from connected vehicles and aggregate the locally trained models to provide a federated customized model

Server 306a also include communication circuit 331 that include wireless transceiver circuit 332 with an associated antenna 334. The communication circuits can provide for vehicle-to-everything (V2X) communications capabilities for connecting with vehicle 320 via network 290, and other vehicles in the network. Models and/or related data stored in database 335 may be exchanged with vehicles connected to the NFL network.

Vehicle 320 may be any type of vehicle, for example, but not limited to, a car; a truck; a sports utility vehicle; a bus; a semi-truck; a drone or any other roadway-based conveyance. Vehicle 320 may be implemented as vehicle 100 of FIG. 1 and can comprises hierarchical federated learning system 200 of FIG. 2. Vehicle 320 may have V2X communication capabilities, allowing vehicles to communicate with edge devices, roadside infrastructure, and the like. Vehicle 320 may also communicate with other vehicles over vehicle-to-vehicle (V2V) communications. It should be understood that sometimes, a vehicle itself may act as a network node, edge computing device, or a combination thereof. Furthermore, in some embodiments, a vehicle itself may act as an edge server.

The architecture 300 provides a hierarchical framework for federated learning, in which edge servers 306a-306n may be used to aggregate models trained locally by vehicles (e.g., vehicle 320) according to characteristics experienced by the vehicles. That is, each edge server 306 can aggregate a characteristic-centric models for each area 314 on corresponding each edge server 306 from models that have been locally trained on data at connected vehicles (e.g., vehicle 320) having similar characteristics.

When vehicle 320 joins the hierarchical federated learning network, the hierarchical federated learning network may need to decide which edge server 306 the vehicle 320 should be connect to for federated learning. For example, in the case of geolocation based hierarchical federated learning, the hierarchical federated learning network may need to decide if the vehicle connects to edge server 306a serving section 314a, edge server 306n serving section 314n, or another server. In this case, the decision may be relativity straightforward because there may exist clear characteristics (such as, position data form, for example, a vehicle positioning system 272).

However, in the case of more subjective characteristics, the decision may not be as obvious. For example, architecture 300 may include a fourth slice of edge servers for each metropolitan area 314. This fourth slice may comprise a number of edge servers for providing a subjective characteristic-centric models. For example, in the case different driving styles (e.g., aggressive, cautious, anxious, etc.), each edge server may be provided for generating a customized driving style-centric model. In this case, the hierarchical federated learning network may need to decide which edge server to connect a vehicle in a manner that reduces data heterogeneity in the hierarchical federated learning network.

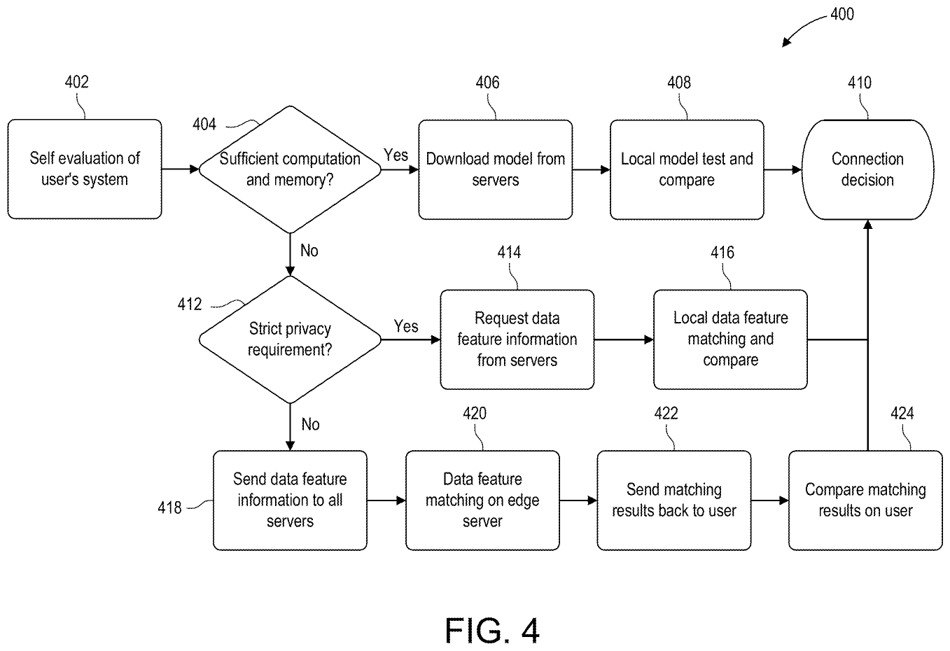

FIG. 4 is a flow chart illustrating example operations for vehicular assisted hierarchical federated learning in accordance with various embodiments disclosed herein. FIG. 4 provides a process 400 for reducing data heterogeneity in federated learning networks using a vehicle-to-edger serve association scheme based on vehicular system heterogeneity. Process 400 may be implemented as instructions, for example, stored on hierarchical federated learning circuit 210, that when executed by one or more processors perform one or more operations of process 400. In another example, process 400 may be implemented as instructions stored on hierarchical federated learning system 333, that when executed by one or more processors to perform one or more operations of process 400. The process 400 will be described below with reference to FIG. 3 as an illustrative example. However, one skilled in the art will appreciate that the embodiments disclosed herein are not to be limited to this implementation only. For example, while the following description will be made with reference to vehicular systems, the embodiments disclosed herein may be applied to other systems as desired.

At operation 402, evaluation of vehicle conditions is initiated. For example, vehicle 320 may trigger a self-evaluation of vehicular system conditions specific to vehicle 320 responsive to joining a hierarchical federated learning network, such as architecture 300. This self-evaluation may be initiated to enable the vehicle 320 to decide which edge server of a number of edge servers 306 is an optimal edge server of vehicle 320 to contribute to hierarchical federated learning. In various example, operation 402 comprises obtaining system-specific conditions, such as at least one of computational resources and privacy requirements of the vehicle 320. For example, hierarchical federated learning client 205 may request measures of computational resources (e.g., computation power and/or memory capacity) from hierarchical federated learning circuit 210 and privacy requirement settings from privacy setting circuit 284. While the foregoing and the following is described with reference to edge servers 360, in other examples, the edge servers may be a lower slice (or level), for example, in the case of driving style applications.

In an example, upon joining the hierarchical federated learning network, vehicle 320 may detect the plurality of edge servers 306. In this way, the vehicle 320 recognizes which edge servers 306 are available and accessible for contributing to hierarchical federated learning.

At operation 404, a determination is made as to whether or not the vehicle has sufficient computation power and sufficient memory capacity to download all models of accessible edge servers. As used herein, accessible edge servers or available edge servers refers to edge servers that are within a communication range, for example, a communication range of communication circuit 201. For example, vehicle 320 may be able to communicatively connect to a number of edge servers 306. Each edge server 306 may host a characteristic-centric model that can be trained and/or utilized in the hierarchical federated learning network. Each characteristic-centric model may be associated with a corresponding computation power required to train the model and/or a computation power required to apply the characteristic-centric model. In an example, the vehicle 320 may ping edge servers 306 and request a polling of characteristic-centric models from edge severs that respond to the ping. The response from each edge server may include an identification of a characteristic-centric model hosted on the respective edge server and corresponding computational resource requirements (e.g., computation power and/or memory capacity).

A determination can be made whether or not the vehicle 320 has sufficient computation power necessary to execute all of the characteristic-centric model. For example, with reference to FIG. 2, processor 206 may be considered to have sufficient computation power if the processor is able to test all the characteristic-centric models using vehicle data. That is, for example, processor 206 may be considered to have sufficient computation power if it can run each characteristic-centric model with its own data, calculate a result for each characteristic-centric model, compare this result with a ground truth for each characteristic-centric model, and determine if each characteristic-centric model works well or not. According to various embodiments, sufficiency of the computation power may be based on the ability to test all characteristic-centric models and obtain a determination of whether each works well or not within a set period of time. The period of time may be set based on a desired performance of the hierarchical federated learning network dependent on a desired amount of time to render a decision. In an example, hierarchical federated learning client 205 may determine whether or not processor 206 has sufficient computation power, for example, based on hardware implementations of processor 206. In another example, one or more of edger serves 306 may make this determination by accessing specifications of vehicle 320.

Furthermore, each characteristic-centric model requires a predetermined amount of memory to store the characteristic-centric model. A determination can be made at operation 404 as to whether or not vehicle 320 has sufficient memory capacity available to store all of the characteristic-centric models. For example, with reference to FIG. 2, memory 208 is considered to have sufficient memory capacity if the memory 208 is able to store all the characteristic-centric models. In an example, hierarchical federated learning client 205 may determine whether or not memory 208 has sufficient memory capacity. In another example, one or more of edger serves 306 may make this determination by accessing inquiring with of vehicle 320.

If the determination at operation 404 is YES, the vehicle 320 downloads each of the characteristic-centric models from accessible edge servers 306 at operation 406. For example, vehicle 320 downloads each available characteristic-centric model from a corresponding edger server 306 via communication circuit 201. In various embodiments, downloading a characteristic-centric model may include download model parameters that describe the characteristic-centric model hosted on the edge server. The parameters are stored in memory for testing by the vehicle 320.

At operation 408, the vehicle 320 tests each of the characteristic-centric models using data collected at the vehicle 320. For example, hierarchical federated learning client 205 may acquire vehicle data from sensors 252 and/or vehicle systems 258 and separately run each characteristic-centric model on the collected data. Each characteristic-centric model is ran on the collected data as inputs, and the hierarchical federated learning client 205 calculates a result of each characteristic-centric model. Hierarchical federated learning client 205 compares each result to ground truth of each characteristic-centric model to determine an accuracy value for each characteristic-centric model. The closer the result is to the ground truth, the higher the accuracy value is attributed to that characteristic-centric model. hierarchical federated learning client 205 then identifies the characteristic-centric models having the best accuracy. The identified model represents the optimal characteristic-centric model for the vehicle 320, at least with respect to the available characteristic-centric models.

At operation 410, vehicle 320 makes a connection decision, which includes selecting the edge server 306 hosting the optimal characteristic-centric model identified in operation 408. The vehicle 320 can then contribute to hierarchical federated learning via the selected edge server. For example, once the optimal characteristic-centric model is identified, the vehicle 320 can remain connected to the selected edge server (closing connections to unselected edge servers), train the optimal characteristic-centric model using data collected from sensors 252 and/or vehicle systems 258, and upload the locally trained model to the selected edge sever (e.g., upload model parameters determined through locally training the model). The edge server can then aggregate the locally trained model to refine the characteristic-centric model. As a result, data heterogeneity in the optimal characteristic-centric model is reduced because the vehicle 320 identified the optimal characteristic-centric model using its own data. Thus, the optimal characteristic-centric model is trained using similarly situated data. In another example, once the optimal characteristic-centric model is identified, the vehicle 320 can run the optimal characteristic-centric model using data collected from sensors 252 and/or vehicle systems 258 to accomplish a task.

Operations 404 through 410 may represent a first example association protocol that is based, at least in part, on system condition heterogeneity. More particularly, operations 404 through 410 consider system specific conditions in computation resources, such as computation power and memory capacity of vehicle 320, to select the first association protocol. This protocol identifies which characteristic-centric model may be optimal for the vehicle 320 by directly downloading characteristic-centric models from the accessible edge servers and testing the models locally at the vehicle. This protocol can assist the vehicle 320 in selecting the optimal model because ground truth evaluation results of the characteristic-centric models are directly available to vehicle 320. Moreover, this first association protocol does not require an exchange of personal or private information, thus strict privacy requirements can be maintained. However, the first association protocol may require significant computation resources needed to download each characteristic-centric model and then test all of them on local vehicle data. Therefore, operation 404 checks to ensure that the vehicle 320 has sufficient computational resources. Furthermore, due to the potentially significant computational resources needed, the first association protocol may be more beneficial in a case where strict privacy requirements are set in the privacy setting circuit 284.

Accordingly, if the determination at operation 404 is NO (e.g., computational resources are insufficient), process 400 proceeds to operation 412, where privacy requirements of the vehicle 320 are checked. For example, privacy requirements may be set in privacy setting circuit 284 as described above. If strict privacy requirements are set (e.g., YES at operation 412), the process 400 proceeds to operation 414.

At operation 414, the vehicle 320 requests model-side data feature information for each characteristic-centric model from each respective accessible edge servers 306. According to embodiment disclosed herein, model-side data feature information can include statistical analytics information describing model parameters and not the model parameters themselves, such as mean, maximum, minimum, distribution, variance of each feature of the model. Separate model-side data feature information is request for each characteristic-centric model, and each set of mode-side data feature information is representative of a corresponding characteristic-centric model. At operation 416, the vehicle 320 compares vehicle-side data feature information with the model data feature information to identify an optimal characteristic-centric model for vehicle 320. The vehicle-side data feature information is derived locally at the vehicle using data acquired from sensors 252 and vehicle systems 258.

The process 400 proceeds to operation 410, at which the vehicle 320 selects the edge server hosting the optimal characteristic-centric model identified at operation 416. For example, once the optimal characteristic-centric model is identified, the vehicle 320 requests to download the optimal characteristic-centric model from the selected edge server. In one example, the vehicle 320 can then train the downloaded model using data collected from sensors 252 and/or vehicle systems 258 and upload the locally trained model to the selected edge sever. The edge server can then aggregate the locally trained model to refine the characteristic-centric model. As a result, data heterogeneity in the optimal characteristic-centric model is reduced because the vehicle 320 identified the optimal characteristic-centric model using its own data. In another example, once the optimal characteristic-centric model is downloaded, the vehicle 320 can run the optimal characteristic-centric model using data collected from sensors 252 and/or vehicle systems 258 to accomplish a task.

This approach, referred to as a second example association protocol comprised of operations 404 and 412-416, avoids downloading the entirety of all characteristic-centric models. Instead, only data feature information of each characteristic-centric model is downloaded to the vehicle 320. For example, vehicle 320 can request statistical analytics information (operation 414), such as mean and variance of each feature, from each edge server. In an illustrative example, data feature information for a given characteristic-centric model can be provided as a mean value feature vector f={f₁, f₂, . . . , fₙ}, where fᵢ is the mean value of data feature i and the data has n different features. On the vehicle side, similar data feature information can be derived from raw vehicle data and stored, which can be denoted by mean value feature vector g={g₁, g₂, . . . , gₙ}. The distance between data feature information of a given characteristic-centric model and the data feature information of the vehicle can be computed, for example, by a Euclidean distance between vectors f and g (operation 416). The vehicle 320 identifies the characteristic-centric model resulting in the shortest Euclidean distance as the optimal characteristic-centric model (operation 416) and selects the edge sever hosting this characteristic-centric model (operation 410). While the foregoing is described with reference to mean values, other statistical information, such as variance, can also be used to compute the distance between characteristic-centric model and vehicle data in a similar way. Furthermore, a Euclidean distance is used herein as an example, other measures of distance between feature vectors may be used, such as but not limited to, Minkowski distance, Manhattan distance, Hamming distance, Cosine distance, and so on.

In this example, the computation can be performed on the vehicle side. The vehicle 320 may check n features for all accessible edge servers. Thus, the time complexity for the second protocol can be determined as O(kn), where k is the number of accessible edge servers. The number of available edger servers may be smaller than the number of features by several magnitude. Therefore, the time complexity may be linear to the number n of features. The space complexity may be determined as O(n), because the vehicle 320 may use extra memory to store the statistical information of the n features. Compared with the first association protocol, the communication cost and computational cost of the second association protocol are both reduced at the vehicle side. However, vehicle 320 provides some statistical information to the edge servers so that the edge server can send the appropriate information to vehicle 320 for data feature matching. For example, vehicle 320 may identify the data information needed (e.g., identification of statistical information describing the data features) by the vehicle 320 to perform the comparison of data features. Thus, the second protocol may be suitable for users who have limited computation resources (e.g., NO determination at operation 404) and strict privacy requirements (e.g., YES determination at operation 412).

However, if the determination at operation 412 is NO (e.g., lenient or mild strict privacy requirements), the process 400 proceeds to operation 418 where the vehicle 320 sends vehicle-side data feature information to each accessible edge server. The vehicle-side data feature information may be similar to the vehicle-side data feature information used in operation 416 (e.g., vector g={g₁, g₂, . . . , gₙ} in one example). Each edge server 306 then performs data feature matching at operation 420 using respective model-side data feature information (e.g., denoted by vector f={f₁, f₂, . . . , fₙ} in one example). For example, each edge server computes a Euclidean distance between its vector f and vehicle-side vector g.

At operation 422, the results of the matching may be transmitted by each edger server 306 to the vehicle 320. Vehicle 320 then compares the matching results at operation 424 to identify an optimal characteristic-centric model. For example, vehicle 320 identifies the characteristic-centric model corresponding to the shortest Euclidean distance as the optimal characteristic-centric model. Once the optimal characteristic-centric model is identified, vehicle 320 selects the edge server hosting the optimal characteristic-centric model identified at operation 410. In another example, edge servers 306 may transmit matching results to a one of severs 306 (or a central server), which identifies the optimal characteristic-centric model from the matching results. The identification can be communicated to the vehicle 320.

Thus, similar to the second association protocol, the third association protocol (e.g., operations 404, 412, and 418-424) can use statistical information to estimate the difference between vehicle data and characteristic-centric models hosted on edge servers. However, in the third association protocol, most of the computation is performed at the edge servers, each of which has sufficient computational and storage resources to perform the computations. The vehicle may need to send vehicle-side data feature information to all accessible edge servers, which the edge servers use for matching computation.

From the perspective of the vehicle, the time complexity may be O(1) because servers have finished the computation. The space complexity may be O(n) as the vehicle stores its statistical information of all data features. The third association protocol uses minimum computational resources, as compared to the other protocols. However, the communication cost may increase as more data is transmitted from the vehicle to edge servers. Furthermore, more time may be required to make the decision at operation 410, because there are several rounds of communication between vehicle 320 and edge servers 306 arrive at a final selection and the edge servers may perform computation for multiple vehicles in parallel. Thus, the third association protocol may be beneficial for vehicles with limited computational resources and low requirements on computation speed and privacy.

Table 1 below shows a matrix of the three association protocols described above and corresponding costs with respect to time, memory capacity/space, computation, privacy, and estimation accuracy.

TABLE 1

| | Time | Space | Commu- | | |
|---|---|---|---|---|---|
| | Com- | Com- | nication | | Estimation |
| | plexity | plexity | Cost | Privacy | Accuracy |
| Protocol | High | High | Middle | Well | High |
| 1 | | | | Preserved | |
| Protocol | Middle | Middle | Low | Partly | Middle |
| 2 | | | | Preserved | |
| Protocol | Low | Low | High | Badly | Middle |
| 3 | | | | Preserved | |

Accordingly, an applicable vehicle-to-edge server association protocol can be selected based on vehicle system conditions, which are heterogenous between vehicles. By associating vehicles to edge servers using the association scheme disclosed herein, data heterogeneity between vehicles contributing to hierarchical federated learning can be significantly reduced by ensuring data acquired under similar scenarios is used to train models. Therefore, a characteristic-centric model with improved performance can be aggregated on an edge server, while taking into consideration system heterogeneity at vehicles in the network.

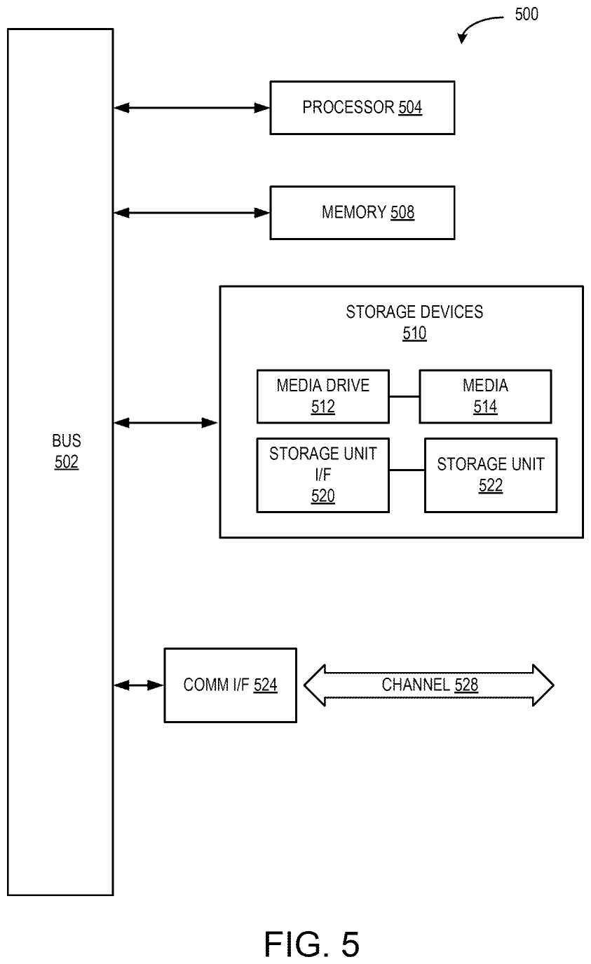

As used herein, the terms circuit and component might describe a given unit of functionality that can be performed in accordance with one or more embodiments of the present application. As used herein, a component might be implemented utilizing any form of hardware, software, or a combination thereof. For example, one or more processors, controllers, ASICs, PLAs, PALs, CPLDs, FPGAs, logical components, software routines or other mechanisms might be implemented to make up a component. Various components described herein may be implemented as discrete components or described functions and features can be shared in part or in total among one or more components. In other words, as would be apparent to one of ordinary skill in the art after reading this description, the various features and functionality described herein may be implemented in any given application. They can be implemented in one or more separate or shared components in various combinations and permutations. Although various features or functional elements may be individually described or claimed as separate components, it should be understood that these features/functionality can be shared among one or more common software and hardware elements. Such a description shall not require or imply that separate hardware or software components are used to implement such features or functionality.

Where components are implemented in whole or in part using software, these software elements can be implemented to operate with a computing or processing component capable of carrying out the functionality described with respect thereto. One such example computing component is shown in FIG. 5. Various embodiments are described in terms of this example-computing component 500. After reading this description, it will become apparent to a person skilled in the relevant art how to implement the application using other computing components or architectures.

Referring now to FIG. 5, computing component 500 may represent, for example, computing or processing capabilities found within a self-adjusting display, desktop, laptop, notebook, and tablet computers. They may be found in hand-held computing devices (tablets, PDA's, smart phones, cell phones, palmtops, etc.). They may be found in workstations or other devices with displays, servers, or any other type of special-purpose or general-purpose computing devices as may be desirable or appropriate for a given application or environment. Computing component 500 might also represent computing capabilities embedded within or otherwise available to a given device. For example, a computing component might be found in other electronic devices such as, for example, portable computing devices, and other electronic devices that might include some form of processing capability.

Computing component 500 might include, for example, one or more processors, controllers, control components, or other processing devices. This can include a processor, and/or any one or more of the components making up hierarchical federated learning system 200 of FIG. 2 and/or edge servers 302, 304, and/or 306 of FIG. 3. Processor 504 might be implemented using a general-purpose or special-purpose processing engine such as, for example, a microprocessor, controller, or other control logic. Processor 504 may be connected to a bus 502. However, any communication medium can be used to facilitate interaction with other components of computing component 500 or to communicate externally.

Computing component 500 might also include one or more memory components, simply referred to herein as main memory 508. For example, random access memory (RAM) or other dynamic memory, might be used for storing information and instructions to be executed by processor 504. Main memory 508 might also be used for storing temporary variables or other intermediate information during execution of instructions to be executed by processor 504. Computing component 500 might likewise include a read only memory (“ROM”) or other static storage device coupled to bus 502 for storing static information and instructions for processor 504.

The computing component 500 might also include one or more various forms of information storage mechanism 510, which might include, for example, a media drive 512 and a storage unit interface 520. The media drive 512 might include a drive or other mechanism to support fixed or removable storage media 514. For example, a hard disk drive, a solid-state drive, a magnetic tape drive, an optical drive, a compact disc (CD) or digital video disc (DVD) drive (R or RW), or other removable or fixed media drive might be provided. Storage media 514 might include, for example, a hard disk, an integrated circuit assembly, magnetic tape, cartridge, optical disk, a CD or DVD. Storage media 514 may be any other fixed or removable medium that is read by, written to or accessed by media drive 512. As these examples illustrate, the storage media 514 can include a computer usable storage medium having stored therein computer software or data.

In alternative embodiments, information storage mechanism 510 might include other similar instrumentalities for allowing computer programs or other instructions or data to be loaded into computing component 500. Such instrumentalities might include, for example, a fixed or removable storage unit 522 and an interface 520. Examples of such storage units 522 and interfaces 520 can include a program cartridge and cartridge interface, a removable memory (for example, a flash memory or other removable memory component) and memory slot. Other examples may include a PCMCIA slot and card, and other fixed or removable storage units 522 and interfaces 520 that allow software and data to be transferred from storage unit 522 to computing component 500.

Computing component 500 might also include a communications interface 524. Communications interface 524 might be used to allow software and data to be transferred between computing component 500 and external devices. Examples of communications interface 524 might include a modem or soft modem, a network interface (such as Ethernet, network interface card, IEEE 802.XX or other interface). Other examples include a communications port (such as for example, a USB port, IR port, RS232 port Bluetooth® interface, or other port), or other communications interface. Software/data transferred via communications interface 524 may be carried on signals, which can be electronic, electromagnetic (which includes optical) or other signals capable of being exchanged by a given communications interface 524. These signals might be provided to communications interface 524 via a channel 528. Channel 528 might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media. Such media may be, e.g., memory 508, storage unit 520, media 514, and channel 528. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing component 500 to perform features or functions of the present application as discussed herein.

It should be understood that the various features, aspects and functionality described in one or more of the individual embodiments are not limited in their applicability to the particular embodiment with which they are described. Instead, they can be applied, alone or in various combinations, to one or more other embodiments, whether or not such embodiments are described and whether or not such features are presented as being a part of a described embodiment. Thus, the breadth and scope of the present application should not be limited by any of the above-described exemplary embodiments.

Terms and phrases used in this document, and variations thereof, unless otherwise expressly stated, should be construed as open ended as opposed to limiting. As examples of the foregoing, the term “including” should be read as meaning “including, without limitation” or the like. The term “example” is used to provide exemplary instances of the item in discussion, not an exhaustive or limiting list thereof. The terms “a” or “an” should be read as meaning “at least one,” “one or more” or the like; and adjectives such as “conventional,” “traditional,” “normal,” “standard,” “known.” Terms of similar meaning should not be construed as limiting the item described to a given time period or to an item available as of a given time. Instead, they should be read to encompass conventional, traditional, normal, or standard technologies that may be available or known now or at any time in the future. Where this document refers to technologies that would be apparent or known to one of ordinary skill in the art, such technologies encompass those apparent or known to the skilled artisan now or at any time in the future.

The presence of broadening words and phrases such as “one or more,” “at least,” “but not limited to” or other like phrases in some instances shall not be read to mean that the narrower case is intended or required in instances where such broadening phrases may be absent. The use of the term “component” does not imply that the aspects or functionality described or claimed as part of the component are all configured in a common package. Indeed, any or all of the various aspects of a component, whether control logic or other components, can be combined in a single package or separately maintained and can further be distributed in multiple groupings or packages or across multiple locations.

Additionally, the various embodiments set forth herein are described in terms of exemplary block diagrams, flow charts and other illustrations. As will become apparent to one of ordinary skill in the art after reading this document, the illustrated embodiments and their various alternatives can be implemented without confinement to the illustrated examples. For example, block diagrams and their accompanying description should not be construed as mandating a particular architecture or configuration.

What is claimed is:

1. A method for vehicular assisted hierarchical federated learning, the method comprising:
responsive to joining a hierarchical federated learning network, obtaining vehicular system conditions of a vehicle;
exchanging data between the vehicle and a plurality of edge servers of the hierarchical federated learning network according to a vehicle-to-edge server association protocol that is based on the vehicular system conditions;
identifying a machine learning model for the vehicle from a plurality of machine learning models hosted on the plurality of edge servers using data acquired by the vehicle; and
at least one of:
training the identified machine learning model to perform a task using the data acquired by the vehicle to produce a locally trained machine learning model; and
applying the data acquired by the vehicle to the identified machine learning model to perform a task.

2. The method of claim 1, further comprising:
selecting the vehicle-to-edge server association protocol from a plurality of vehicle-to-edge server association protocols using the vehicular system conditions.

3. The method of claim 1, wherein vehicular system conditions comprises at least one of: computational resources of the vehicle and a privacy requirement settings of the vehicle.

4. The method of claim 3, wherein vehicular system conditions comprises privacy requirements and computational resources of the vehicle.

5. The method of claim 1, further comprising:
determining that the vehicle comprises insufficient computational resources for storing and running each machine learning model of the plurality of machine learning models,
wherein selecting the vehicle-to-edge server association protocol from the plurality of vehicle-to-edge server association protocols is based on the determination.

6. The method of claim 5, further comprising:
responsive to the determination that the vehicle comprises insufficient computational resources for storing and running each machine learning model of the plurality of machine learning models, checking privacy requirement settings of the vehicle,
wherein selecting the vehicle-to-edge server association protocol from the plurality of vehicle-to-edge server association protocols is based on the privacy requirement settings.

7. The method of claim 6, further comprising:
responsive to the privacy requirement settings being set to strict privacy requirements, requesting data feature information from each edge server of the plurality of edge servers, data feature information representative of each machine learning model; and
performing feature matching between data feature information of each machine learning and data feature information of the vehicle derived from the data acquired by the vehicle,
wherein identifying the machine learning model for the vehicle from the plurality of machine learning models hosted on the plurality of edge servers comprises identifying the machine learning model corresponding to data feature information that is closest to the data feature information of the vehicle.

8. The method of claim 6, further comprising:
responsive to the privacy requirement settings being set to lenient privacy requirements, transmitting, to each edge server of the plurality of edge servers, data feature information of the vehicle derived from the data acquired by the vehicle; and
receiving data matching results from each edge server of the plurality of edge servers, wherein the data matching results from each edge sever comprises a measure of similarity between data feature information of the machine learning model hosted by a respective edge server and the data feature information of the vehicle,
wherein identifying the machine learning model for the vehicle from the plurality of machine learning models hosted on the plurality of edge servers comprises identifying the machine learning model corresponding to a data matching result having highest measure of similarity.

9. A vehicle, comprising:
a communication circuit configured to exchange communications with edge servers of a hierarchical federated learning network;
a memory storing instructions; and
one or more processors communicably coupled to the memory and configured to execute the instructions to:
obtain vehicular system conditions of the vehicle responsive to joining a hierarchical federated learning network;
exchange data with a plurality of edge servers of a hierarchical federated learning network according to a vehicle-to-edge server association protocol that is based on the vehicular system conditions;
identify a machine learning model for the vehicle from a plurality of machine learning models hosted on the plurality of edge servers using data acquired by the vehicle; and
at least one of:
train the identified machine learning model to perform a task using the data acquired by the vehicle to produce a locally trained machine learning model; and
apply the data acquired by the vehicle to the identified machine learning model to perform a task.

10. The vehicle of claim 9, wherein the one or more processors are further configured to execute the instructions to select the vehicle-to-edge server association protocol from a plurality of vehicle-to-edge server association protocols using the vehicular system conditions.

11. The vehicle of claim 9, wherein vehicular system conditions comprises at least one of: computational resources of the vehicle and a privacy requirement settings of the vehicle.

12. The vehicle of claim 11, wherein vehicular system conditions comprises privacy requirements and computational resources of the vehicle.

13. The vehicle of claim 9, wherein the one or more processors are further configured to execute the instructions to:
determine that the vehicle comprises insufficient computational resources for storing and running each machine learning model of the plurality of machine learning models,
wherein selecting the vehicle-to-edge server association protocol from the plurality of vehicle-to-edge server association protocols is based on the determination.

14. The vehicle of claim 13, wherein the one or more processors are further configured to execute the instructions to:
responsive to the determination that the vehicle comprises insufficient computational resources for storing and running each machine learning model of the plurality of machine learning models, check privacy requirement settings of the vehicle,
wherein selecting the vehicle-to-edge server association protocol from the plurality of vehicle-to-edge server association protocols is based on the privacy requirement settings.

15. The vehicle of claim 14, wherein the one or more processors are further configured to execute the instructions to:
responsive to the privacy requirement settings being set to strict privacy requirements, request data feature information from each edge server of the plurality of edge servers, data feature information representative of each machine learning model; and
perform feature matching between data feature information of each machine learning and data feature information of the vehicle derived from the data acquired by the vehicle,
wherein identifying the machine learning model for the vehicle from the plurality of machine learning models hosted on the plurality of edge servers comprises identifying the machine learning model corresponding to data feature information that is closest to the data feature information of the vehicle.

16. The vehicle of claim 14, wherein the one or more processors are further configured to execute the instructions to:
responsive to the privacy requirement settings being set to lenient privacy requirements, transmitting, to each edge server of the plurality of edge servers, data feature information of the vehicle derived from the data acquired by the vehicle; and
receiving data matching results from each edge server of the plurality of edge servers, wherein the data matching results from each edge sever comprises a measure of similarity between data feature information of the machine learning model hosted by a respective edge server and the data feature information of the vehicle,
wherein identifying the machine learning model for the vehicle from the plurality of machine learning models hosted on the plurality of edge servers comprises identifying the machine learning model corresponding to a data matching result having highest measure of similarity.

17. A server of a hierarchical federated learning network, the server comprising:
a communication circuit configured to exchange communications with at least one vehicle of a hierarchical federated learning network;
a memory storing instructions and a machine learning model; and
one or more processors communicably coupled to the memory and configured to execute the instructions to:
exchange data with the at least one vehicle of the hierarchical federated learning network according to a vehicle-to-edge server association protocol selected based on on vehicular system conditions of the at least one vehicle;
based on the vehicle-to-edge server association, receive a model trained locally by the at least one vehicle using data acquired by the vehicle; and
aggregate the machine learning model and the locally trained model to generate an aggregate machine learning model.

18. The server of claim 17, wherein vehicular system conditions comprises computational resources of the vehicle and a privacy requirement setting of the vehicle.

19. The server of claim 18, wherein the one or more processors are further configured to execute the instructions to:
based on the privacy requirement settings of the at least one vehicle being set to strict privacy requirements, transmit data feature information representative of the machine learning model; and
based on a comparison of the data feature information of the machine learning model with data feature information of the at least one vehicle, transmitting model parameters of the machine learning model to the at least one vehicle.

20. The server of claim 18, wherein the one or more processors are further configured to execute the instructions to:
based on the privacy requirement settings of the at least one vehicle being set to lenient privacy requirements, receiving data feature information of the at least one vehicle derived from the data acquired by the vehicle;
performing data matching data feature information of the machine learning model and the received data feature information of the at least one vehicle;
transmitting data matching results to the at least one vehicle; and
responsive to a request from the at least one vehicle, transmitting model parameters of the machine learning model to the at least one vehicle, wherein the request is based on the transmitted data matching results.
